(19) United States
(12) Patent Application Publication
(10) Pub. No.: US 2012/0216940 A1
(43) Pub. Date: Aug. 30, 2012

(54) METHOD FOR MAKING COVERS

(75) Inventors: Aleksander Macha, Gliwice (PL); Krystian Nawrat, Gliwice (PL); Michael Shier, Dorset (GB)

(73) Assignee: Opus Spolka z o. o., Gliwice (PL)

(21) Appl. No.: 13/404,333

(22) Filed: Feb. 24, 2012

(30) Foreign Application Priority Data
Feb. 28, 2011 (PL) P-394057

(51) Int. Cl. B32B 37/16

(52) U.S. Cl. 156/70

(57) ABSTRACT

A method for making a cover for a document includes placing first and second sheets of a transparent film on a rigid plane. The first sheet is attached to the rigid plane and is welded to the second sheet along an edge. A medium is inserted between the first and second sheets. The first and second sheets with the medium inserted in between are joined together. The first and second sheets can be joined together with the medium inserted in between by cold lamintion, thermal lamination, or by self-adhesive surfaces of the first and second sheets.

The present application claims priority to Polish Patent Application No. P-394057, filed Feb. 28, 2011. This prior application is incorporated by reference in its entirety herein.

The present disclosure relates to a method for making covers for a set of documents, which covers can include a presentation of an illustration or other information on the covers.

Known methods for making a cover including a presentation of an illustration or other information at its top include:

gluing a photo or image, previously applied on a medium, on the cover,

forming transparent pockets designed for inserting photos or printed materials, and

laminating an illustration or information medium with self-adhesive laminating film and gluing the laminated illustration or information medium on the cover.

Such covers can have a number of defects. For example, a photo or other printed information glued is typically made on a short-lived medium, which is not aesthetically pleasing and gradually wears out during use. Exact positioning of the medium in relation to the cover during its gluing can be difficult. The use of a self-adhesive laminating film for laminating of the medium and then attaching it to the cover requires double positioning and double laminating. Additionally, intensive use of an already finished cover can lead to detachments of the corners of the attached medium.

The present disclosure provides an easy method for making durable and impressive covers, which can include illustrations and/or other information at their tops.

According to the present disclosure, a cover for a document may be made by a method comprising:

placing first and second sheets of a transparent film on a rigid plane;

attaching the first sheet to the rigid plane;

welding the first sheet to the second sheet along an edge thereof;

inserting a medium between the first and second sheets; and

joining the first sheet and the second sheet with the medium inserted therebetween together.

The sheets with the medium in between can be joined together by cold lamination, thermal lamination, or by self-adhesive surfaces of the sheets.

In one variation, the first and second sheets are for thermal lamination. In another variation, the first and second sheets are for cold lamination. In yet another variation of the method, both the first and second sheets of transparent film have surfaces that are self-adhesive to the medium and do not require the use of a laminator.

In a variation of the method, two sheets of transparent film are placed on a rigid plane, wherein one sheet is attached to the rigid plane and is thermally welded to the other sheet along the shorter edge or the longer edge (if the edges of the sheet differ).

In yet another variation of the method, both sheets of the transparent film are placed on the rigid plane in a specially made small cavity having dimensions of the medium.

In yet another variation of the method, a first sheet of transparent film is attached to a rigid plane, and a second sheet of transparent film is thermally welded to the first sheet along two edges, for example, the shorter edge and the longer edge (if the edges of the sheet differ).

In accordance with the present disclosure, the whole unit, including the sheets with the medium in-between, can be joined together.

The sheets of transparent film can be formed from a highly transparent polyester film. This film can be covered on one side with a hot-melt adhesive. The temperature at which the adhesive changes from a dry state to a liquid state and starts to present adhesive properties is preferably at least about 80° Celsius. The thickness of the sheets is preferably about 60-100 microns. The rigid plane preferably is rigid cardboard covered with an aesthetically pleasing material and preferably has a thickness of about 1.5 to 2.5 mm, more preferably about 2 mm.

The medium preferably includes an illustration or other information. This medium is, for example, paper or a film. Preferably, the medium is such that printing can be performed thereon. The properties of such medium preferably correspond to the applied printing method.

The method according to the present disclosure is described more closely using drawings, in which:

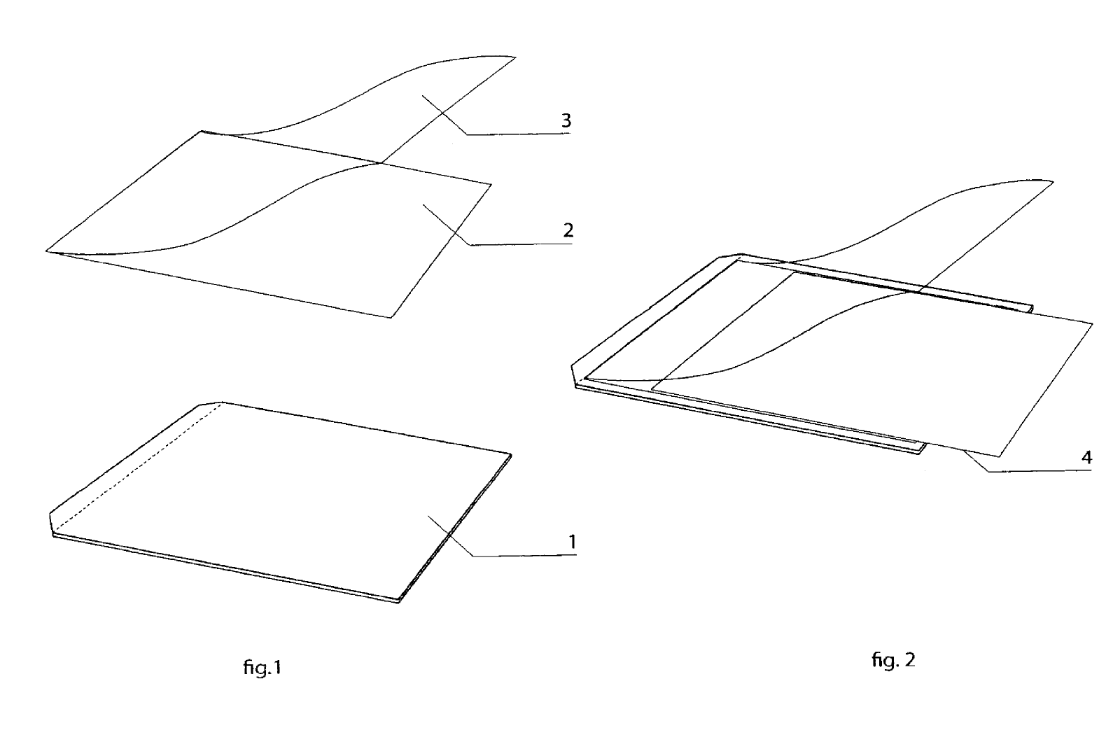

FIG. 1 shows an example method that employs consecutive stages during making of a cover, and

FIG. 2 shows a stage of inserting a medium in between two sheets of film prior to laminating them together.

According to the method of the present disclosure, two sheets 2 and 3 of a transparent film for thermal lamination are placed on a rigid plane 1. The rigidity of the rigid plane 1 is preferably greater than the rigidity of the sheets 2 and 3 of the transparent film. The sheet 2 is attached to the plane 1 and the sheet 2 is welded to the sheet 3 along a shorter edge. An illustration or other information on a medium 4 (e.g., paper) is inserted between the partially open sheets 2 and 3 and the whole unit is subjected to laminating. A ready, aesthetically pleasing, and durable cover is obtained that can be used for binding documents using thermal gluers, binders, or by crimping ridges in a metal or plastic rail. The illustration or other information may be made on a short-lived medium.

In a variant of the method according to the present disclosure, the sheets of transparent film 2 and 3 are placed on the rigid plane 1 in a specially formed small cavity having a size of the medium 4. The cavity facilitates positioning of the medium 4 and provides a smooth surface after lamination. The sheets of transparent film 2 and 3 can be thermally welded together along two edges, for example, the shorter edge and the longer edge, which facilitates positioning of the medium 4.

1. A method for making a cover for a document, the method comprising:
placing first and second sheets of a transparent film on a rigid plane;
attaching the first sheet to the rigid plane;
welding the first sheet to the second sheet along an edge thereof;
inserting a medium between the first and second sheets; and
joining the first sheet and the second sheet with the medium inserted therebetween together.

2. The method according to claim 1, wherein the joining includes laminating the first and second sheets with the medium inserted therebetween.

3. The method according to claim 1, wherein the first sheet is welded to the second sheet along a shorter edge or a longer edge thereof.

4. The method according to claim 1, wherein the rigid plane includes a cavity having dimensions of the medium, and the first and second sheets are placed in the cavity.

5. The method according to claim 1, wherein the first sheet is attached to the rigid plane, and the first sheet is welded to the second sheet along two edges.

6. The method according to claim 4, wherein the first sheet is welded to the second sheet along a shorter edge and a longer edge.

7. The method according to claim 2, wherein the first and second sheets are for thermal lamination.

8. The method according to claim 2, wherein the first and second sheets are for cold lamination.

9. The method according to claim 1, wherein the medium includes an illustration or other information.

10. The method according to claim 1, wherein the first and second sheets each include a self-adhesive surface, and the self-adhesive surfaces of the first and second sheets are attached to the medium.
